(19) United States
(12) Patent Application Publication
(10) Pub. No.: US 2011/0033680 A1
(43) Pub. Date: Feb. 10, 2011

(54) TRANSPARENT BARRIER LAYER SYSTEM

(75) Inventors: John Fahlteich, Dresden (DE); Matthias Fahland, Dresden (DE); Waldemar Schoenberger, Dresden (DE); Nicolas Schiller, Stolpen OT Helmsdorf (DE)

Correspondence Address: GREENBLUM & BERNSTEIN, P.L.C., 1950 ROLAND CLARKE PLACE, RESTON, VA, 20191, US

(73) Assignee: FRAUNHOFER-GESELLSCHAFT ZUR FOERDERUNG DER ANGEWANDTEN FORSCHUNG E.V., Muenchen (DE)

(21) Appl. No.: 12/937,655

(22) PCT Filed: Apr. 9, 2009
(86) PCT No.: PCT/EP2009/002678

§ 371 Date: Oct. 13, 2010

(30) Foreign Application Priority Data
Apr. 18, 2008 (DE) 10 2008 019 665.7

(51) Int. Cl. B32B 7/02

(52) U.S. Cl. 428/212

(57) ABSTRACT

The invention relates to a transparent barrier layer system on a substrate, wherein the barrier layer system comprises a sequence of individual layers, wherein the individual layers are composed alternately of a layer A and a layer B and wherein a layer A differs from a layer B in terms of the activation energy in the permeation of water vapor with a difference of at least 1.5 kJ/mol.

The invention relates to a transparent barrier layer system. Barrier layers of this type are used for diffusion inhibition and reduce the permeation through a coated substrate. Frequent uses are found wherever certain substances, e.g., foodstuffs as packaged goods or electronic components based on organic semiconductors, are to be prevented from coming into contact with oxygen from the environment or being able to exchange water with the environment. Interest is thereby focused primarily on an oxidative conversion or perishability of the substances to be protected. In addition, among other things the protection of various substances in danger of oxidation is also taken into consideration when they are integrated into lamellar bonds. The protection of these substances is particularly important when the retardation of the oxidative conversion determines the service life of products.

Barrier layers offer in part a very different resistance to various diffusing substances. To characterize barrier layers, the permeation of oxygen (OTR) and water vapor (WVTR) through the substrates provided with the barrier layer under defined conditions are often used. Moreover, barrier layers often have the function of an electrical insulating layer. An important area of use of barrier layers is display applications or solar cells.

Due to the coating with a barrier layer, the permeation through a coated substrate is reduced by a factor that can lie in the single-digit range or can be many orders of magnitude.

Apart from predetermined barrier values, various other target parameters are often expected of a finished barrier layer. Optical, mechanical as well as technological/economic requirements are cited for this by way of example. Barrier layers often should be invisible, thus have to be virtually completely transparent in the visible spectral range. If barrier layers are used in layer systems it is often advantageous if coating steps for applying individual parts of the layer system can be combined with one another.

For the production of barrier layers on flexible substrates such as plastic films or thin metal films, it is economically expedient and in many cases mandatory to carry out the coating in a roll-to-roll process. In a roll-to-roll process, the substrate to be coated is continuously unwound from a roll, guided through the coating chamber and wound up again on a second roll. The movement of the substrate through the process chamber is thereby carried out continuously. In this manner very large surfaces can be coated with high productivity.

The barrier effect of a layer is substantially influenced by the number, size and density of defects inside the layer on which the permeation preferably takes place. Efforts to improve the barrier effect are therefore concentrated primarily on producing layers that are as free from defects as possible.

To produce barrier layers, so-called PECVD methods (plasma-enhanced chemical vapor deposition) are also often used. These are used on a variety of substrates for different layer materials. For example, it is known to deposit SiO₂ and Si₃N₄ layers having a thickness of 20 to 30 nm on 13 μm PET substrates [A. S. da Silva Sobrinho et al., J. Vac. Sci. Technol. A 16 (6), November/December 1998, p. 3190-3198]. With an operating pressure of 10 Pa, permeation values of WVTR=0.3 g/m²d and OTR=0.5 cm³/m²d can be achieved in this manner.

With the coating with SiOₓ for transparent barrier layers on PET substrate by means of PECVD, an oxygen barrier of OTR=0.7 cm³/m²d can be realized [R. J. Nelson and H. Chatham, Society of Vacuum Coaters, 34^{th} Annual Technical Conference Proceedings (1991) p. 113-117]. Other sources for this technology are also based for transparent barrier layers on PET substrate on permeation values in the order of magnitude of WVTR=0.3 g/m²d and OTR=0.5 cm³/m²d [M. Izu, B. Dotter, S. R. Ovshinsky, Society of Vacuum Coaters, 36th Annual Technical Conference Proceedings (1993) p. 333-340].

Furthermore, it is known to produce barrier layers with gradients by means of PECVD methods [A. G. Erlat et al., Society of Vacuum Coaters, 48^{th} Annual Technical Conference Proceedings (2005), p. 116-120)]. Process parameters are thereby changed during the coating process, that is, during the growth of the layer on the substrate, so that the layer properties form as gradients: The advantage of this method is that the layers have few defects. WVTR values around 10⁻⁴ g/(m²d) are achieved. One disadvantage of this method is that layers form insufficient optical transparency. Basically, this method is not suitable for a roll-to-roll coating either, since the embodiment of the gradient layer by a process control varying in terms of time requires a stationary process control (that is, with fixed substrate).

Furthermore, an SiO₂ layer with a gradient regarding the material properties is known, for example, from EP 0 311 432 A2. A mechanical adjustment of the permeation barrier to the plastic film and thus a better mechanical resistance is to be achieved thereby. Basically, this method is not suitable for a roll-to-roll coating either, since the embodiment of the gradient layer by a process control varying in terms of time likewise requires a stationary process control.

It is known to apply barrier layers by means of sputtering. Sputtered individual layers often show better barrier properties than PECVD layers. For sputtered AINO on PET, for example, WVTR=0.2 g/m²d and OTR=1 cm³/m²d are given as permeation values [Thin Solid Films 388 (2001) 78-86]. In addition, numerous other materials are known which are used for the production of transparent barrier layers in particular through reactive sputtering. However, the layers produced in this manner likewise have barrier effects that are too low for display applications. Another disadvantage of layers of this type lies in their low mechanical loadability. Damage that occurs through technologically unavoidable stresses during further processing or use usually lead to a marked deterioration of the barrier effect. This makes sputtered individual layers often unusable for barrier uses with high demands. Furthermore, with these methods it is also observed that above a certain layer thickness the barrier effect deteriorates again or at least an improvement no longer occurs with increasing layer thickness.

It is furthermore known with the deposit of diffusion barrier layers, that is, barrier layers, to use magnetron plasmas for a plasma polymerization (EP 0 815 283 B1); [S. Fujimaki, H. Kashiwase, Y. Kokaku, Vacuum 59 (2000) p. 657-664]. These are PECVD processes that are directly maintained through the plasma of a magnetron discharge. The use of a magnetron plasma for PECVD coating to deposit layers with a carbon skeleton is cited by way of example, wherein CH₄ is used as a precursor. However, layers of this type likewise have an inadequate barrier effect for display applications.

Alternatively, individual layers are also vapor-deposited as barrier layers. Through PVD methods of this type, different materials can likewise be directly or reactively deposited on a variety of substrates. For barrier uses, for example, the reactive vapor deposition of PET substrates with Al₂O₃ is known [Surface and Coatings Technology 125 (2000) 354-360]. Permeation values of WVTR=1 g/m²d and OTR=5 cm³/m²d are hereby achieved. These values are likewise much too high to use materials coated in this manner as barrier layers in displays. They are frequently mechanically even less loadable than sputtered individual layers. Furthermore, a direct evaporation is usually associated with a high evaporation speed or evaporation rate. This necessitates correspondingly high substrate speeds in the production of thin layers usual in barrier applications in order to avoid an excessive impingement of the substrate with layer material. A combination with process steps that require a much lower throughput speed is thus virtually impossible in continuous pass plants. This applies in particular to the combination with sputtering processes.

Furthermore, it is known to apply barrier layers in several coating steps. One method is formed by the so-called PML process (polymer multilayer) (1999 Materials Research Society, p. 247-254); [J. D. Affinito, M. E. Gross, C. A. Coronado, G. L. Graff, E. N. Greenwell and P. M. Martin, Society of Vacuum Coaters, 39^{th} Annual Technical Conference Proceedings (1996) p. 392-397]. In the PML process a liquid acrylate film is applied to the substrate by means of evaporators, which film is hardened by means of electron beam technology or UV irradiation. This does not have a particularly high barrier effect per se. Subsequently a coating of the hardened acrylate film with an oxidic intermediate layer takes place, on which in turn an acrylate film is applied. This method is repeated several times as needed. The permeation values of a layer stack produced in this manner, that is, a combination of individual acrylate layers with oxidic intermediate layers, is below the measurement level of conventional permeation measuring instruments.

Disadvantages lie above all in the necessary use of complex systems engineering. Moreover, initially a liquid film forms on the substrate, which must be hardened. This leads to an increased system soiling, which shortens maintenance cycles. The process for vapor depositing the acrylate is likewise optimized for high line speeds and therefore hard to combine in-line with slower coating processes, in particular a sputtering process.

From DE 196 50 286 C2 it is known to form a barrier layer system from an inorganic barrier layer and an inorganic-organic hybrid polymer. The effect of the inorganic-organic hybrid polymer hereby lies among other things in the closing of defects in the inorganic barrier layer. The disadvantage of this method is that it is fundamentally not suitable for roll-to-roll, since the inorganic-organic hybrid polymer cannot be applied in a vacuum, but the inorganic barrier layer has to be applied in a vacuum. Each individual layer must therefore be applied in a different coating plant.

In DE 10 2004 005 313 A1 an inorganic layer is combined with a second layer that is applied in a special magnetron-based PECVD process. In this case too Al₂O₃ as an inorganic layer forms one of the possible embodiments.

It is common to all of the known approaches that a high barrier effect is achieved, in that at least one material with a high barrier effect is deposited on a substrate by means of a corresponding coating technology. For the further improvement of the barrier effect, in some methods this barrier layer is combined with further layers in order thus to further improve the barrier effect by a multiple-layer structure.

To sum up, the following disadvantages of known methods can be cited: with individual barrier layers, above a thickness dependent on the layer material and the coating method, no more improvement of the barrier effect can be achieved. Presumably, thicker layers tend to form defects at which an increased permeation takes place. In order to avoid this problem, in part gradient layers are deposited. However, these are not suitable for roll-to-roll methods.

Another possibility for avoiding or compensating for the formation of defects is multiple barrier layers. The known methods for producing multiple barrier layers are too complex, however, and in part not suitable for roll-to roll. Furthermore, the barrier effect of these multiple barrier layers still cannot be completely explained and thus is not calculable, which is why one is dependent on trial and error methods in the production of multiple barrier layers with predetermined permeation properties.

### OBJECT

The technical object of the invention is therefore to create a barrier film with a transparent barrier layer system, by means of which the disadvantages of the prior art can be overcome. In particular the barrier layer system is to have very good barrier properties with respect to oxygen and water vapor. Furthermore, it should be possible to produce the barrier film by means of roll-to-roll methods. In particular, the barrier layer system should have a high barrier effect.

The technical object is attained through the subject matters with the features of claim 1. Further advantageous embodiments of the invention are described in the dependent claims.

Important information about the permeation mechanism of a layer can be derived from the activation energy. The term activation energy comes from the analytic description of the permeation mechanism. Permeation through a layer is described by the following correlation:

$$P = {P}_{0} \cdot {e}^{\frac{{E}_{P}}{RT}}$$

In the formula, P stands for the permeation, P₀ stands for the permeation coefficient, R is the universal gas constant, T is the temperature and E_{P} is the activation energy.

With a temperature-dependent measurement of the permeation it is possible to determine the activation energy. If the measured values for the permeation are plotted over the temperature on the logarithmic scale, a connection of the individual values produces a straight line, the ascent of which characterizes the activation energy. In an experimental manner, for example, the activation energy of an uncoated substrate and the activation energy of the substrate with a coating can be determined and compared in this way.

The knowledge of the activation energy permits the following statements: If the activation energy does not change or changes only slightly due to the coating compared to the uncoated substrate, this is called a defect-dominated permeation. This means that the permeating particles pass through the layer unhindered at the defect locations (also called macroscopic defects). However, the layer per se (in the regions in which it does not have any defects) is impermeable for the particles.

However, if the activation energies of the coated and the uncoated substrate differ greatly, the permeation through the layer occurs not only through the macroscopic defects, but also through the layer material itself. This is also called solids diffusion. Often with layers of this type the permeation through the defect locations is negligible compared to the solids diffusion.

Surprisingly, it was found that the barrier properties of a layer system are better, the greater the difference of the activation energies of adjacent layers or materials. If adjacent layers or materials have a difference of at least 1.5 kJ/mol with respect to their activation energy as separate layers on a substrate, good barrier properties are already achieved. Further qualitative improvements of the barrier properties can be achieved with a difference of at least 3.5 kJ/mol and 5 kJ/mol.

A transparent barrier layer system according to the invention on a substrate therefore comprises a sequence of individual layers, wherein the individual layers are composed alternately of a layer A and a layer B, wherein the substrate with an individual layer A and the substrate with an individual layer B differ regarding the activation energy with the permeation of water vapor with a difference of at least 1.5 kJ/mol.

The activation energy of a layer depends on several factors. On the one hand, the layer material and the layer thickness have an influence on the activation energy. On the other hand, however, the activation energy of a layer also changes when it is deposited by means of different methods.

The activation energy of layers A and B cannot be easily determined directly. However, it is possible, for example, to deposit a layer A as an individual layer on a substrate and a layer B as an individual layer on the substrate, to determine the associated activation energies and to calculate their difference.

Layers for layer A and layer B can be determined experimentally via the variation of the three parameters (material, thickness, deposit method). If layer A and layer B as an individual layer on a substrate to be coated have a sufficiently large difference in terms of the activation energy determined, it is ensured that layer A and layer B as alternating layers of a layer system on the substrate will ensure good barrier properties.

For example, a compound of at least one element from the group aluminum, zinc, tin, silicon, titanium, zircon with at least one of the elements oxygen, nitrogen is suitable for a layer A. For example, a material of a compound of at least one element from the group aluminum, zinc, tin, silicon, titanium, zircon with at least one of the elements oxygen, nitrogen, carbon can be used for a layer B. A layer A as well as a layer B can thereby be first facing towards a substrate as an individual layer.

However, it is advantageous with respect to good barrier properties if the first individual layer adjoining the substrate has an activation energy that has the largest possible difference from the activation energy of the uncoated substrate and if the second individual layer adjoining the substrate has an activation energy that is approximately as large as the activation energy of the uncoated substrate.

For example, layer A can be deposited by means of sputtering and layer B can be deposited by means of PECVD. As a special embodiment of a PECVD process, layer B can also be deposited by means of a magnetron PECVD method, for example.

Sputtering hereby means a coating method in which the particles are atomized from a target material through a plasma which is produced through the ionization of a working gas in an electric field. The particles then condensing on the substrate form the desired layer. In addition to pure atomization, however, a chemical reaction of the atomized particles with a gas admitted to a working chamber can also take place. In this case, the reaction products form the layer, wherein the method is called reactive sputtering.

With a method known as PECVD, a monomer is fragmented by plasma action and the individual fragments form the layer on the substrate through polymerization. With a method known as magnetron PECVD, a magnetron is used as a source for the plasma in a PECVD process.

A transparent barrier layer system according to the invention is suitable, for example, for the protection of electronic components such as OLEDs, solar cells or organic electronic circuits. Components of this type are assembled in multiple numbers in production to form a band-shaped formation and rolled up as a roll. The application of a barrier layer system onto these electronic components takes place usually in two ways.

On the one hand, a direct encapsulation of the components takes place in that the barrier layer system is deposited directly onto the components. In a roll-to-roll process, the components serve directly as a substrate to be coated, are unwound from a roll, guided through a coating chamber and rolled up again on a second roll. The movement of the substrate through the process chamber thereby takes place continuously. In this manner very large surfaces can be coated with high productivity. Disadvantages of this method lie in the stress of the component by the layer application and the necessity of the technology transfer for the production of the barrier layers to the manufacturer of the components.

Alternatively, the barrier layer system can also be deposited onto a polymer film. In this case, the manufacturer of the components needs only to apply the film to the surfaces to be protected by means of a suitable technology. A polymer film of this type can be composed, for example, of PET, PEN, ETFE, PC, PMMA, FEP or PVDF. The polymer film is also hereby provided with the barrier layer system by means of a roll-to-roll process. The layers A and B can thereby be deposited one after the other in a coating plant without vacuum interruption.

### EXEMPLARY EMBODIMENT

The invention is explained in more detail below based on a preferred exemplary embodiment. The figures show:

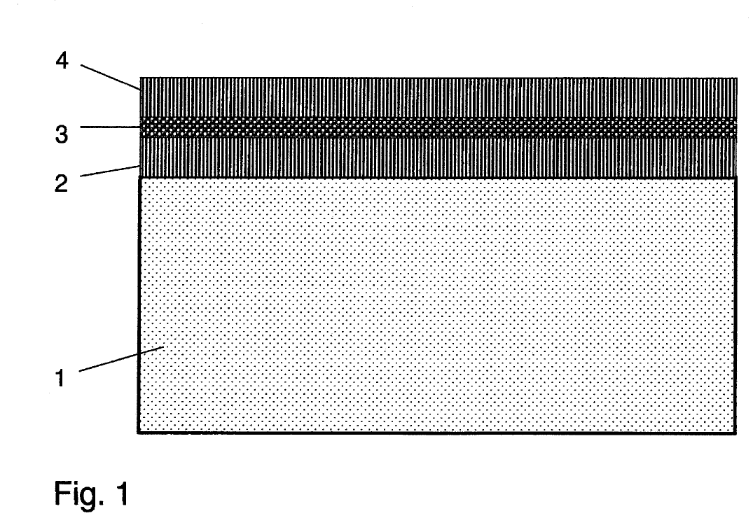

FIG. 1 A diagrammatic sectional representation of a barrier film with a barrier layer system according to the invention;

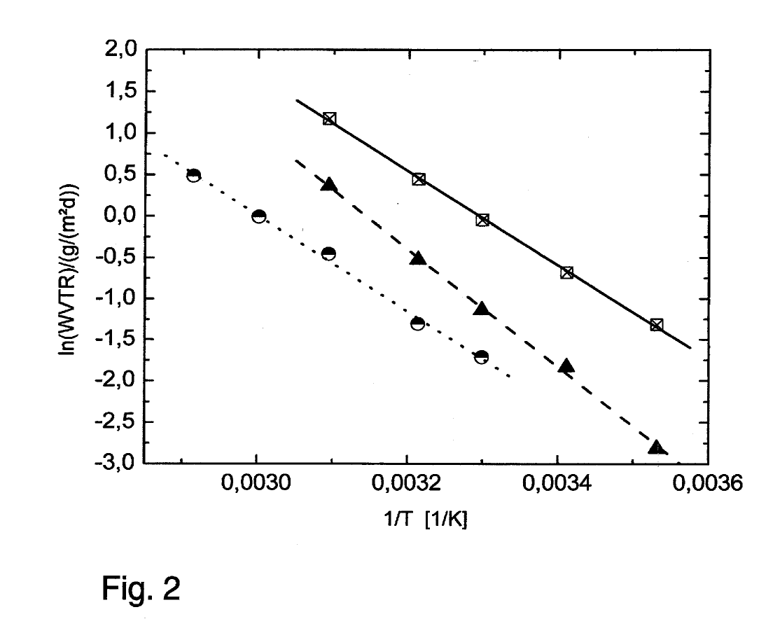

FIG. 2 A graphic representation of the dependency of permeation and temperature.

In FIG. 1 a barrier film with a barrier layer system according to the invention is shown diagrammatically in section. The barrier film comprises a substrate 1 of PET 75 μm thick, on which first a layer 2 of ZnSnO_{X} 75 nm thick, followed by a layer 3 of SiO_{X}C_{Y} 65 nm thick and subsequently again a layer 4 of ZnSnO_{X} 75 nm thick were deposited.

However, before the barrier layer system could be deposited on the PET substrate 1, experimentally an individual layer of ZnSnO_{X} 75 nm thick was deposited by means of magnetron sputtering and an individual layer 65 nm thick of SiOₓC_{y} was deposited by means of magnetron PECVD in each case separately on a PET substrate 1 and the associated activation energy of the permeation of water vapor through the coated films was determined.

The activation energy of the permeation of water vapor through a film coated with ZnSnOx layer is 3.6 kJ/mol. In the case of a film coated with SiOxCy, the activation energy is 8.6 kJ/mol. The activation energy of the PET film without a layer is, like the film coated with ZnSnOx, 3.6 kJ/mol. The difference regarding the activation energy with the two films coated with individual layers of 5 kJ/mol indicates a high barrier effect with an alternate coating on the PET substrate 1.

In a roll-to-roll process, the following were subsequently deposited on the substrate 1:

Firstly, layer 2 by means of reactive magnetron sputtering of a target of a zinc-tin alloy, followed by layer 3 by means of magnetron PECVD with the intake of the monomer HMDSO and subsequently layer 4 in turn by means of reactive magnetron sputtering.

The barrier film realized in this manner had a value for the water vapor permeation rate of 0.007 g/m²*d (measured with catalytic measurement methods at 38° C. and 90% relative air humidity).

With substrate 1, coated with an individual layer of ZnSnO_{X} 75 nm thick, however, only a value of 0.045 g/m²*d could be determined. The doubling of the layer thickness to 150 nm also brought an improvement only to 0.02 g/m²*d.

The dependency of the permeation displayed logarithmically over the temperature is shown graphically in FIG. 2. To this end, first the permeation of water vapor through an uncoated PET film 75 μm thick is determined at different temperatures, the pairs of values entered in the diagram and the points produced connected by a straight line. The upper straight line (with the squares) in FIG. 2 is thereby assigned to the uncoated PET film. The center straight line (with the triangles) is assigned to a PET film 75 μm thick, which is covered with a silicon oxide layer 65 nm thick with a residual carbon content and was deposited by means of PECVD. The lower straight line (with the circles) resulted with a PET film 75 μm thick with a zinc-tin oxide layer 75 nm thick, which was deposited by means of magnetron sputtering.

While the upper and the lower straight lines run approximately parallel, which means an approximately equal activation energy in the permeation of water vapor, the center straight line shows a steeper curve and thus a higher activation energy with the permeation of water vapor. It can thus be derived from FIG. 2 that a PET film 75 μm thick with a layer system comprising two zinc-tin oxide layers 75 nm thick, in which a silicon oxide layer 65 nm thick is embedded, has good barrier properties.

1. Transparent barrier layer system on a substrate, characterized in that the barrier layer system comprises a sequence of individual layers, wherein the individual layers are composed alternately of a layer A and a layer B, wherein the substrate with an individual layer A and the substrate with an individual layer B differ regarding the activation energy with the permeation of water vapor with a difference of at least 1.5 kJ/mol.

2. Transparent barrier layer system according to claim 1, characterized in that the difference of the activation energy in the permeation of water vapor through the substrate with an individual layer A and the substrate with an individual layer B is at least 5 kJ/mol.

3. Transparent barrier layer system according to claim 1, characterized in that layer A is deposited by means of sputtering and layer B is deposited by means of PECVD.

4. Transparent barrier layer system according to claim 3, characterized in that layer B is deposited by means of magnetron PECVD.

5. Transparent barrier layer system according to claim 1, characterized in that the layer A is composed of a compound of at least one element from the group aluminum, zinc, tin, silicon, titanium, zircon with at least one of the elements oxygen, nitrogen.

6. Transparent barrier layer system according to claim 1, characterized in that layer B is composed of a compound of at least one element from the group aluminum, zinc, tin, silicon, titanium, zircon with at least one of the elements oxygen, nitrogen, carbon.

7. Transparent barrier layer system according to claim 1, characterized in that the first individual layer facing towards the substrate is a layer A.

8. Transparent barrier layer system according to claim 1, characterized in that the first layer facing towards the substrate is a layer B.

9. Transparent barrier layer system according to claim 1, characterized in that the substrate is a polymer film.

10. Transparent barrier layer system according to claim 9, characterized in that the polymer film is composed of PET, PEN, ETFE, PC, PMMA, FEP or PVDF.

11. Transparent barrier layer system according to claim 1, characterized in that the substrate is an electronic component to be protected.

12. Transparent barrier layer system according to claim 1, characterized in that the layers A and B are deposited directly one after the other in a coating plant.
